(19) United States
(12) Patent Application Publication
(10) Pub. No.: US 2003/0229792 A1
(43) Pub. Date: Dec. 11, 2003

(54) Apparatus for distributed access control

(76) Inventors: Adrian Baldwin, Bristol (GB); Marco Casassa Mont, Bristol (GB); Joseph N. Pato, Lexington, MA (US)

Correspondence Address: Richard P. Berg, LADAS & PARRY, Suite 2100, 5670 Wilshire Boulevard, Los Angeles, CA, 90036-5679, US

(21) Appl. No.: 10/394,396

(22) Filed: Mar. 21, 2003

(30) Foreign Application Priority Data
Mar. 22, 2002 (GB) 0206733.8

(51) Int. Cl. H04L 9/00

(52) U.S. Cl. 713/185

(57) ABSTRACT

Computer apparatus for accessing by a user an electronic service provided by a remote service provider comprising a receiver for receiving an authorisation policy, wherein the authorisation policy defines access requirements to the electronic service; and a trusted device for determining the users authorisation to access the electronic service based upon the authorisation policy and at least one attribute associated with the user, wherein the trusted device is arranged to inhibit the user accessing the authorisation policy.

### TECHNICAL FIELD

The present invention relates to an apparatus for distributed access control.

### BACKGROUND

As the popularity of the Internet has increased, so accordingly has the demand for Internet services. However, associated with the increased demand for Internet services has been the increasing emphasis on authorization to ensure that a user is entitled to a specific service.

Many Internet services maintain their own authorisation databases, where authorisation for a service is determined based upon the contents of the databases.

Further, user attributes (i.e. credentials) can be used in the authorisation process, for example credential issuers may provide a user with credentials relating to payment issues; summarising people's rights; business roles or even professional qualifications, thereby allowing a service provider to provide a service based upon the contents of the credential. For example a credential may be for an employee of a specific company having a specific role, where the service providers authorisation rules (i.e. policies) can be used to determine the user's authorisation to the service based on the user having a particular role; working for a given company and having the correct payment or credit credentials. Obviously, however, a party trusted by the service provider must be responsible for issuing the credentials.

FIG. 1 illustrates an example of a user 10 placing a purchasing request 11 with an electronic service 12 (e-service)via an electronic network 16; where the purchasing request 11 is associated with a users corporate credential 15. On receipt by the e-service 12 of the purchasing request 11, and copy of the associated corporate credential 15, the request 11 and credential 15 are passed to the e-service's access control system 13. The access control system 13 contains a set of rules 14 (i.e. policies) from which the access control system 13 determines the appropriate rule(s) for determining the authorisation requirements for any given service request. Additionally the access control system may obtain additional information relating to the request, for example this may include obtaining company account information from the e-services local database; or it could include obtaining payment credentials either from the user or a credit company. Once the access control system has obtained all the necessary information the access control system executes the rules to check whether the transaction should be allowed.

However, the computation required to perform the necessary authorisations can be quite considerable and when run on a central server associated with the service can result in a bottleneck, especially when dealing with many service requests.

Further, the provision of credentials to a service provider can result in the unwanted dissemination of private information relating to the user.

It is desirable to improve this situation.

### SUMMARY OF THE INVENTION

In accordance with a first aspect of the present invention there is provided a computer apparatus for accessing by a user an electronic service provided by a remote service provider comprising a receiver for receiving an authorisation policy, wherein the authorisation policy defines access requirements to the electronic service; and a trusted device for determining the users authorisation to access the electronic service based upon the authorisation policy and at least one attribute associated with the user, wherein the trusted device is arranged to inhibit the user accessing the authorisation policy.

This provides the advantage of allowing authorization policies to be distributed via trusted devices such that authorisation can be established at the user's computer node, thereby allowing the e-service or interacting enterprises to outsource the complex authorisation tasks in a safe manner.

Preferably the trusted device is arranged to inhibit the remote service provider accessing the at least one attribute.

Preferably the trusted device is tamper resistant.

Preferably the trusted device is arranged to produce a certified record of the users authorisation for the service.

Preferably the computer apparatus further comprises a transmitter for providing the certified record to the remote service provider.

Preferably a plurality of certified records can be combined by the computer apparatus.

In accordance with a second aspect of the present invention there is provided a distributed access control system comprising a first computer node associated with a service provider, a second computer node associated with a user, and a trusted device associated with the second computer node for determining the users authorisation to access an electronic service of the service provider based upon an authorisation policy received from the first computer node and user attributes associated with the user.

Preferably the trusted device is arranged to inhibit the user accessing the authorisation policy.

In accordance with a third aspect of the present invention there is provided a distributed access control system comprising a first computer node associated with a service provider, a second computer node associated with a user, wherein the second computer node includes a trusted device for determining the users authorisation to access an electronic service of the service provider based upon an authorisation policy received from the first computer node and user attributes associated with the user.

Preferably the trusted device is arranged to inhibit the user accessing the authorisation policy.

Preferably the first computer node includes a trusted device.

Preferably the trusted device included with the first computer node and the trusted device included with the second computer node are arranged to allow the trusted devices to communicate in a peer to peer relationship.

This invention provides the advantage of removing potential authorisation bottlenecks at the e-service provider while providing confidentiality. A trusted party associated with the trusted device can provide assurances that the authorisation information is only ever in an unencrypted form within tamper resistant hardware. If a single trusted device within an enterprise, which is used to authorisation e-services for the enterprise, results in a bottleneck for the enterprise the enterprise can obtain additional trusted devices for installation within the enterprise computing system.

A trusted device can be installed in a computer apparatus that is used to initiate an e-service request or, alternatively, all service requests for a given Enterprise can be directed through a trusted device installed on a computer apparatus coupled to the Enterprises internal network.

### BRIEF DESCRIPTION OF THE DRAWINGS

For a better understanding of the present invention and to understand how the same may be brought into effect reference will now be made, by way of example only, to the accompanying drawings, in which:

FIG. 1 illustrates a prior art authorisation system;

FIG. 2 illustrates a distributed access control system in accordance with an embodiment of the present invention;

FIG. 3 illustrates a motherboard of a computer apparatus adapted to include a trusted device according to an embodiment of the present invention;

FIG. 4 illustrates a trusted device according to an embodiment of the present invention;

FIG. 5 illustrates a distributed access control system in accordance with an embodiment of the present invention.

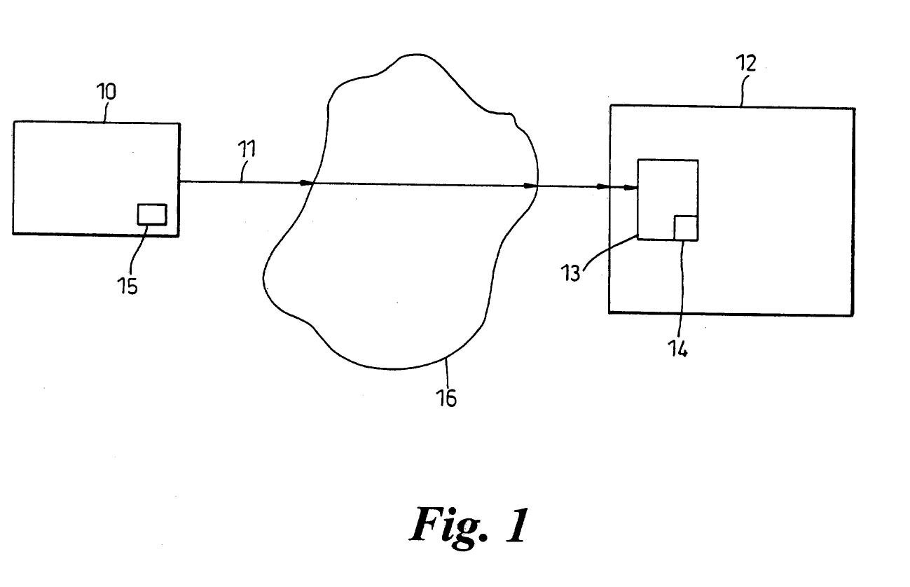

### DETAILED DESCRIPTION OF AN EMBODIMENT OF THE INVENTION

The present exemplary embodiment describes a distributed access control system where the responsibility for the authorisation of a requestor of an e-service is transferred to the requestor, where the requestor uses a trusted device to execute the authorisation. A third party, trusted by both the requestor and the e-service provider, is used to vouch for the integrity of the trusted device, and that the trusted device will maintain confidentiality of both requestor data and e-service data. The trusted third party can be contracted to provide the trusted device to the requestor or, alternatively, to validate a trusted device provided by the requestor.

The trusted device uses cryptographic processes but does not necessarily provide an external interface to those cryptographic processes. Also, a most desirable implementation would be to make the trusted device tamperproof, to protect secrets by making them inaccessible to other computer platform functions and provide an environment that is substantially immune to unauthorised modification. Since tamper-proofing is impossible, the best approximation is a trusted device that is tamper-resistant, or tamper-detecting. The trusted device, therefore, preferably consists of one physical component that is tamper-resistant.

Techniques relevant to tamper-resistance are well known to those skilled in the art of security. These techniques include methods for resisting tampering (such as appropriate encapsulation of the trusted device), methods for detecting tampering (such as detection of out of specification voltages, X-rays, or loss of physical integrity in the trusted device casing), and methods for eliminating data when tampering is detected. It will be appreciated that, although tamper-proofing is a most desirable feature of the present invention, it does not enter into the normal operation of the invention and, as such, is beyond the scope of the present invention and will not be described in any detail herein.

The trusted device is preferably a physical one because it must be difficult to forge. It is most preferably tamper-resistant because it must be hard to counterfeit. It typically has an engine capable of using cryptographic processes.

The use of a tamper proof device ensures privacy between the client and service provider, thereby allowing the authorisation policies to remain confidential to the e-service and the user credentials to remain confidential to the user.

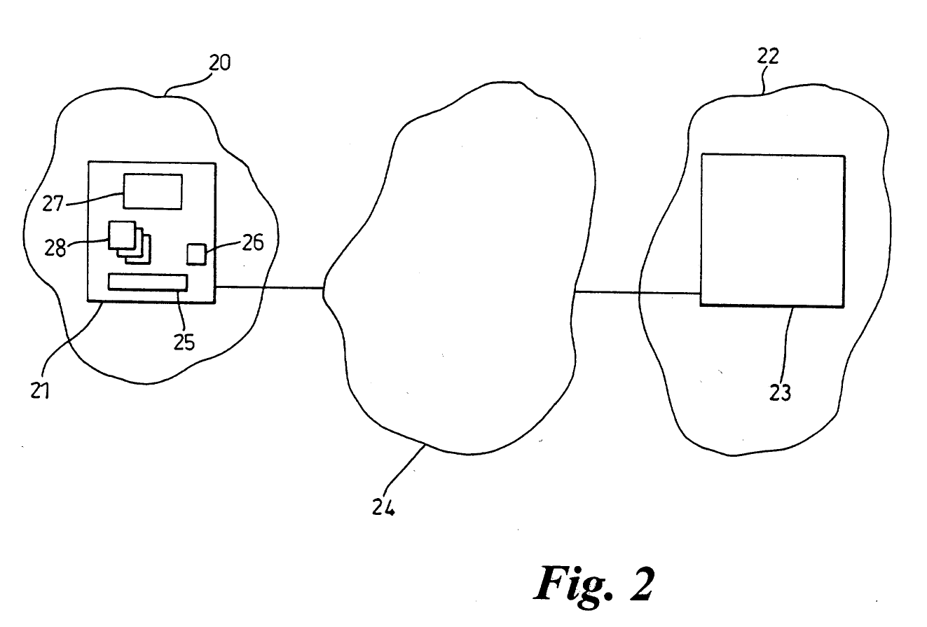

FIG. 2 shows a first business entity 20 having a first computer apparatus 21, and a second business entity 22 having a second computer apparatus 23. The computer apparatus's 21, 23 are coupled via a network 24, for example the Internet, thereby allowing a communication link to be established between the business entities.

It should be noted that a business entity will typically have a plurality of computer apparatus's, having different users, that communicate over an internal network, however, for the purpose of this embodiment each business entity only utilise a single computer apparatus, as described above.

For the purposes of this implementation the first business entity 20 acts as the intended user of an e-service provided by the second business entity 22.

The computer apparatus 21 includes the standard features of a keyboard 25, mouse 26 and visual display unit (VDU) 27, which provide the physical ‘user interface’ of the platform. In the computer apparatus there are a plurality of modules 28: these are other functional elements of the computer apparatus of essentially any kind appropriate to that platform (the functional significance of such elements is not relevant to the present invention and will not be discussed further herein).

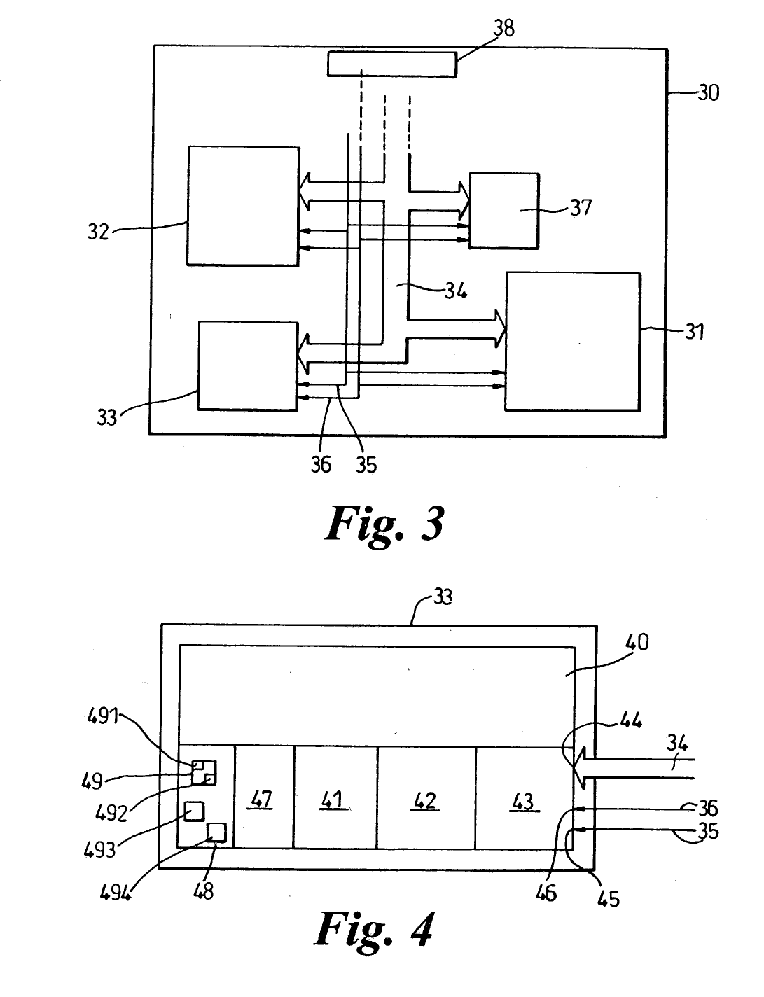

As illustrated in FIG. 3, the motherboard 30 of the computer apparatus 21 includes (among other standard components) a main processor 31, main memory 32, a trusted device 33, a data bus 34 and respective control lines 35 and address lines 36, BIOS memory 37 containing the BIOS program for the computer apparatus 21 and an Input/Output (IO) device 38, which is used to couple the computer apparatus 21 to the network 24, the keyboard 25, the mouse 26 and the VDU 27. The main memory 32 is typically random access memory (RAM).

Although, in the preferred embodiment to be described, the trusted device 33 is a single, discrete component, it is envisaged that the functions of the trusted device 33 may alternatively be split into multiple devices on the motherboard 30, or even integrated into one or more of the existing standard devices of the computer apparatus 21. For example, it is feasible to integrate one or more of the functions of the trusted device 33 into the main processor 31 itself, provided that the functions and their communications cannot be subverted. This, however, would probably require separate leads on the processor 31 for sole use by the trusted functions. Additionally or alternatively, although in the present embodiment the trusted device 33 is a hardware device that is adapted for integration into the motherboard 30, it is anticipated that a trusted device 33 may be implemented as a ‘removable’ device, such as a dongle, which could be attached to the computer apparatus 21 when required. Whether the trusted device is integrated or removable is a matter of design choice. However, where the trusted device 33 is separable, a mechanism for providing a logical binding between the trusted device 33 and the computer apparatus 21 should be present.

Alternatively, however, the trusted device could be incorporated in a stand-alone device coupled to a user's network, whereby the trusted device is accessed via the user's network, thereby allowing the trusted device to be accessed as a back-end component by multiple components, for example workflow systems and e-procurement solutions.

The trusted device 33 comprises a number of blocks, as illustrated in FIG. 4. Specifically, the trusted device 33 comprises: a controller 40 programmed to control the overall operation of the trusted device 33, and interact with the other functions on the trusted device 33 and with the other devices on the motherboard 30; a cryptographic function 41 for signing, encrypting or decrypting specified data with a private key and an associated certificate identifying the third party as the trusted entity where the certificate is used to prove identity and provides an identity under which authorisation tickets are signed (as described below); an authorisation function 42 for determining whether a user is authorised to use a specific e-service based upon credentials associated with the user and an authorisation policy associated with the e-service; and interface circuitry 43 having appropriate ports (44, 45 & 46) for connecting the trusted device 33 respectively to the data bus 34, control lines 35 and address lines 36 of the motherboard 30. Each of the blocks in the trusted device 33 has access (typically via the controller 40) to appropriate volatile memory areas 47 and/or non-volatile memory areas 48 of the trusted device 33, for example to allow storage of user credentials and authorisation policies. Additionally, the trusted device 33 is designed (as stated above), in a known manner, to be tamper resistant.

For reasons of performance, the trusted device 33 may be implemented as an application specific integrated circuit (ASIC). However, for flexibility, the trusted device 33 is preferably an appropriately programmed micro-controller. Both ASICs and micro-controllers are well known in the art of microelectronics and will not be considered herein in any further detail.

Stored in the non-volatile memory 48 of the trusted device 33 is a certificate 49 for the trusted device, a trusted third parties certificate 493 and a service provider's certificate 494. The certificate 49 contains at least a public key 491 and private key 492 of the trusted device 33. Prior to the certificate 49 being stored in the trusted device 33 the certificate 49 is signed by the trusted third party using the trusted third parties private key. The trusted third parties certificate 493 includes the trusted third parties public key. The service provider's certificate 494 includes the service provider's public key.

Although the trusted device is incorporated in a computer apparatus associated with the user the trusted device may be provided and ‘owned’ by the trusted third party.

A preferred process for providing authorisation of a requestor for an e-service will now be described.

A user 20 generates a request for an e-service using a software application (not shown) installed on the users computer apparatus 21, for example a web browser. The request is forwarded to the trusted device 33 within the computer apparatus 21. The request will typically include user credential references, service name, service location and request details. The credentials should be relevant to the requested e-service

The trusted device 33 sends to the e-service 22 a copy of the trusted devices certificate 49. The e-service 22 checks that they trust the trusted third party associated with the trusted device 33 and that the certificate 49 is valid. The e-service 22 responses by sending confirmation back to the trusted device 33 as to whether the trusted device 33 is trusted to run authorisation policies on behalf of the e-service 22.

If the trusted device 33 is recognised by the e-service 22 the secure exchange of data can occur, for example a secure connection can be established, via the network 24, between the e-service 22 and the trusted device 33, such as a SSL connection or data can be exchanged as secured packages, such as PKCS7.

If multiple users are using the same services through a trusted device located on an enterprises local area network LAN the trusted device could maintain a single session with the e-service.

The authorisation function 42 within the trust device 33 needs to obtain the e-services authorisation policies for the requested service and, additionally, may need to obtain information about the user, for example user credentials if the request did not include the actual credentials themselves.

A simple mechanism for obtaining the authorisation polices would be for the trusted device 33 to request the e-service for the authorisation policies over the secure connection. Alternatively, the authorisation polices could be preinstalled within the trusted device 33, within memory 48.

Associated with the authorisation policies will typically be a service model that contains information relating to the requested service, for example a URL for the service and service function parameters, where the service model could be based upon web service definition language WSDL. The service model is associated with a policy name (this could be a hash of the policy).

Authorisation policies may also include access control rules that typically refer to elements in the service model. These set the access requirements to the authorisation polices based upon the required service.

An example of an authorisation policy for a user wishing to place a request to buy an air ticket for a trip to X at the price Y from an electronic service provider could be:

if (Y < 100)

User_Has (creditcard_credential) AND (( X is

member of INTERNALFLIGHT) OR

(( X is member of

INTERNATIONALFLIGHT) AND (User_Has(passport)))
else if (Y > 100)

User_Has (creditcard_credential) AND
Check_Credential (creditcard_credential, Y) AND

(( X is member of

INTERNALFLIGHT) OR

(( X is member of

INTERNATIONALFLIGHT) AND (User_Has(passport)))

where INTERNALFLIGHT and INTERNATIONALFLIGHT are lists defined within the policy definition. The service model would be used to extract the parameters X and Y from the user's request. The above example of an authorisation policy defines that if the ticket costs less than one hundred then check that the user has a credit card and if the flight is an international flight check that the user has a passport credential, and if the amount is greater than one hundred check that the credit card credential is valid and has a sufficient credit limit.

To minimise communication between the requestor 20 and the e-service 22 a number of authorisation polices for different e-services could be downloaded to the trusted device at the same time. The authorisation polices can then be stored in memory 48 within the trusted device 33 ready for any future e-service requests.

The user (i.e. requestor) 20 may include a number of relevant credentials along with the e-service request; alternatively the trusted device 33 may have a cache of the relevant user credentials from which the relevant credentials can be selected. Additionally, the trusted device 33 may have direct access to the users credential wallet, stored in memory 32 on the computer apparatus 21, thereby allowing the trusted device 33 to pull out all the relevant credentials when required. To control access to the users credentials the access controls, provided by the e-service 22, may include authorisation rules on which credentials can be used for which services or whether credentials can be disclosed.

The credential can take the form of a URL to a credential provider, which would require the trusted device 33 to interface with an external credential provider to validate that the credential is sufficient to comply with the relevant e-service authorisation policy.

If the credential takes the form of a URL the request should also contain current credential register lists CRL for the credentials. The trusted device 33 is also ideally programmed with a number of trusted roots for authentication of credential providers and other signed data. However, the authorisation policies may not require the checking of all credential CRLs; for example if a visa credential is being checked for transaction values under £50 then the full validation may be ignored.

The credentials could be based on x509 attribute certificates, SPKI certificates, XML credentials, secure assertion mark-up language SAML or any other convenient format. It is desirable that the credentials are of a standard form and that they are verifiable. The credential will probably be a formatted document signed by the credential issuer.

The once the necessary authorisation policy information and credential information has been obtained the authorization function 42 of the trusted device 33 can then make an authorisation decision based upon the relevant authorisation policy and user credential(s). If the authorisation function 42 determines that the user 20 is authorised to access the requested e-service the trusted device 33 generates an authorisation ticket, where the authorisation ticket confirms the user's authorisation. For example, the authorisation ticket may contain a yes or no decision along with names and hashes of all information packages, and the request details.

The trusted device 33 then signs the authorisation ticket using the trusted device's private key, issued and certified by the trusted third party.

The trusted device 33 can be configured to either forward the signed authorisation ticket to the e-service 22 or back to the user, via an application within the computer apparatus 21, for forwarding to the e-service 22, thereby allowing the e-service 22 to only need perform a simple ticket validation to determine the user's authorisation.

Additionally the e-service 22 can request the authorisation ticket.

The authorisation ticket need not contain details of the users credentials or other information used to make the decisions. Thus the e-service 22 would trust that the correct decision has been made but not know the details of the credentials or even the decision path taken in a complex authorisation policy rule, thereby maintaining the user's credentials confidential.

It should be noted that the e-service 22 could redirect requests for authorisation information to other parties or other services that would simply publish policy and credential information.

Additionally, the authorisation policies and service models can be altered dynamically during the authorisation process.

If the trusted third party needs to check how the trusted device 33 is functioning the trusted device 33 can be arranged to produce a secure audit log that can be enveloped (i.e. encrypted) such that only the root authorisation service can read the data. This can be used to produce periodic audit logs for return to the trusted third party, thereby allowing the trusted third party to validate the consistency of the audit logs and use them in case of a dispute. Additionally, to enhance the audit process and/or for notarisation purposes the trusted device 33 can be arranged to also forward the authorisation ticket to the trusted third party.

The above embodiment describes a simple asymmetric authorisation process where the user (i.e. requestor) places a request for an e-service.

In an alternative embodiment a trusted device 33 can also be incorporated within the e-service provider 22, thereby allowing the e-service trust device to take on various roles, for example the provision of policy information; authentication of data; and interpretation of the authorisation tickets.

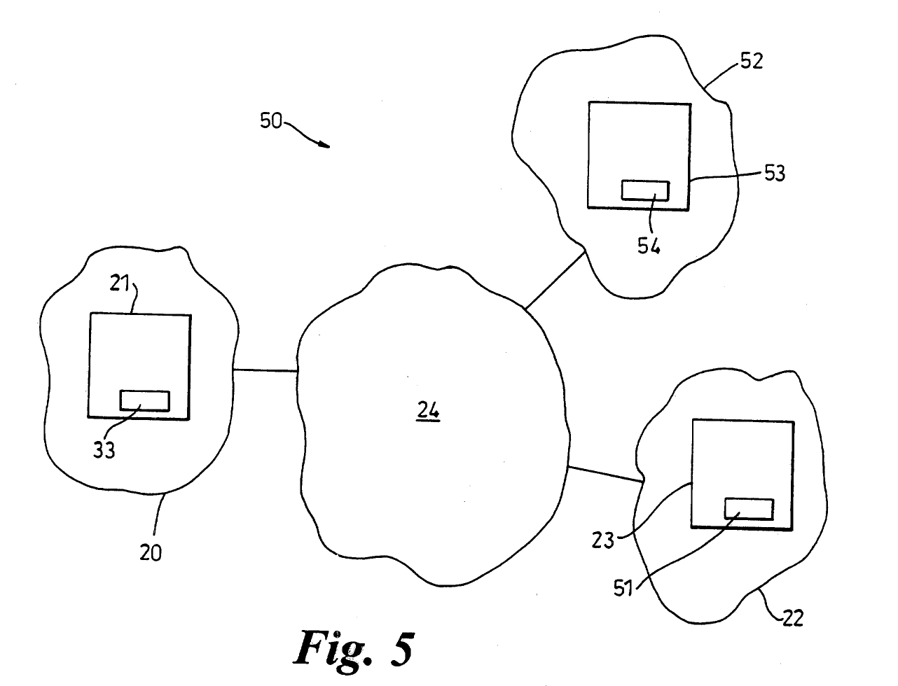

FIG. 5 shows a distributed authorisation system 50 based upon that described above where the e-service provider also has an associated trusted device and includes a secondary e-service provider. In particular FIG. 5 shows a first business entity 20 having a first computer apparatus 21, a second business entity 22 having a second computer apparatus 23, and a third business entity 52 having a third computer apparatus 53, where each computer apparatus 21, 23, 53 within the respective business entity 20, 22, 52 has a trusted device 33, 51, 54, where the trusted devices are as described above. The computer apparatus's 21, 23, 53 are coupled via a network 24, for example the Internet, thereby allowing a communication link to be established between the business entities 20, 22 52.

For the purposes of this implementation the first business entity 20 acts as the intended user of an e-service, the second business entity 22 acts as a primary e-service provider and the third business entity 52 acts as a secondary e-service provider.

The primary e-service 22 communicates directly with its local trusted device 51, which manages the authorisation interactions for the primary e-service. Similar to the embodiment described above the primary e-services trusted device 51 manages a secure session with the users trusted device 33; distributes the authorisation information (or redirect them to an alternative distributor) and receives the associated authorisation tickets. As for the users trusted device 33 the primary e-service trusted device 51 can also produce a secure (signed audit log) with details of all authorised transactions.

As a communication link can be established between the trusted devices 51, 54 of the primary e-service 22 and the secondary e-service 52 the primary e-service 22 can issue authorisation tickets to the secondary e-service 52 on the basis of a larger authorisation ticket received from the user 20. In this way the primary e-services trusted device 51 can provide secure authorisation information for subcontracted services (i.e. from the secondary e-service) without the need to pass client details.

Alternatively the communicating trusted devices could hide some details from the primary e-service whilst releasing them to specific secondary services. Such a system could allow payments to be treated as authorisations with the trusted devices passing authorisation tickets to enable payments.

What is claimed:

1. Computer apparatus for accessing by a user an electronic service provided by a remote service provider comprising a receiver for receiving an authorisation policy, wherein the authorisation policy defines access requirements to the electronic service; and a trusted device for determining the users authorisation to access the electronic service based upon the authorisation policy and at least one attribute associated with the user, wherein the trusted device is arranged to inhibit the user accessing the authorisation policy.

2. Computer apparatus according to claim 1, wherein the trusted device is arranged to inhibit the remote service provider accessing the at least one attribute associated with the user.

3. Computer apparatus according to claim 1, wherein the trusted device is tamper resistant.

4. Computer apparatus according to claim 1, wherein the trusted device is arranged to produce a certified record of the users authorisation for the service.

5. Computer apparatus according to claim 4, further comprising a transmitter for providing the certified record to the remote service provider.

6. Computer apparatus according to claim 5, further comprising means for transmitting the certified record in a secure manner.

7. Computer apparatus according to claim 1, wherein the trusted device is arranged to produce an audit of the authorisation polices used.

8. Distributed access control system comprising a first computer node associated with a service provider, a second computer node associated with a user, and a trusted device associated with the second computer node for determining the users authorisation to access an electronic service of the service provider based upon an authorisation policy received from the first computer node and a user attribute associated with the user.

9. Distributed access control system according to claim 8, wherein the second computer node incorporates the trusted device.

10. Distributed access control system according to claim 8, wherein the trusted device is arranged to inhibit the user accessing the authorisation policy.

11. Distributed access control system according to claim 8, wherein the trusted device is arranged to inhibit the first computer node accessing the user attribute.

12. Distributed access control system according to claim 8, wherein the trusted device is tamper resistant.

13. Distributed access control system according to claim 8, wherein the trusted device is arranged to produce a certified record of the users authorisation for the service.

14. Distributed access control system according to claim 13, further comprising a transmitter for providing the certified record to the first computer node.

15. Distributed access control system according to claim 14, wherein the certified record can be decomposed by the first computer node into a plurality of certificate records for transmitting to other electronic service providers.

16. Distributed access control system according to claim 13, wherein a plurality of certified records can be combined by the second computer node.

17. Distributed access control system according to claim 8, wherein the trusted device is arranged to produce an audit of the authorisation polices used.

18. Distributed access control system according to claim 8, wherein the first computer node has an associated trusted device.

19. Distributed access control system according to claim 18, wherein the trusted device associated with the first computer node and the trusted device associated with the second computer node are arranged to allow the trusted devices to communicate in a peer to peer relationship.

20. Distributed access control system comprising a first computer node associated with a service provider, a second computer node associated with a user, wherein the second computer node includes a trusted device for determining the users authorisation to access an electronic service of the service provider based upon an authorisation policy received from the first computer node and a user attribute associated with the user.

21. Distributed access control system according to claim 20, wherein the trusted device is arranged to inhibit the user accessing the authorisation policy.

22. Distributed access control system according to claim 20, wherein the trusted device is arranged to inhibit the first computer node accessing the user attribute.

23. Distributed access control system according to claim 20, wherein the trusted device is tamper resistant.

24. Distributed access control system according to claim 20, wherein the trusted device is arranged to produce a certified record of the users authorisation for the service.

25. Distributed access control system according to claim 24, further comprising a transmitter for providing the certified record to the first computer node.

26. Distributed access control system according to claim 25, wherein the certified record can be decomposed by the first computer node into a plurality of certificate records for transmitting to other electronic service providers.

27. Distributed access control system according to claim 24, wherein a plurality of certified records can be combined by the second computer node.

28. Distributed access control system according to claim 20, wherein the trusted device is arranged to produce an audit of the authorisation polices used.

29. Distributed access control system according to claim 20, wherein the first computer node includes a trusted device.

30. Distributed access control system according to claim 29, wherein the trusted device included with the first computer node and the trusted device included with the second computer node are arranged to allow the trusted devices to communicate in a peer to peer relationship.
